(19) United States
(12) Patent Application Publication
(10) Pub. No.: US 2008/0233417 A1
(43) Pub. Date: Sep. 25, 2008

(54) OPTICAL POLYMER MATERIAL AND OPTICAL COMPONENT

(75) Inventors: Keiichi Kuramoto, Kadoma-city (JP); Mitsuaki Matsumoto, Hirakata-city (JP); Masaya Nakai, Hirakata-city (JP); Nobuhiko Hayashi, Osaka-city (JP)

Correspondence Address: DITTHAVONG MORI & STEINER, P.C., 918 Prince St., Alexandria, VA, 22314, US

(73) Assignee: Sanyo Electric Co., Ltd., Moriguchi-city (JP)

(21) Appl. No.: 12/053,365

(22) Filed: Mar. 21, 2008

(30) Foreign Application Priority Data
Mar. 23, 2007 (JP) 2007-76981
Feb. 12, 2008 (JP) 2008-30234

(51) Int. Cl. C08K 5/07; B32B 27/08

(52) U.S. Cl. 428/480; 524/356

(57) ABSTRACT

The invention provides an optical polymer material having a low viscosity before curing, a high refractive index of a cured product, little alteration of refractive index under high temperature and high humidity, and an excellent heat resistant shock property and an optical component using the optical polymer material.

The optical polymer material is characterized in that the material contains a fluorene compound having four (meth) acryloyl groups and a (meth) acrylate having an aryl group and may further contain -M-O-M- bond (M is a metal atom), an organometallic polymer having an aryl group, a monofunctional (meth)acrylate and/or a polyfunctional (meth)acrylate.

### BACKGROUND OF THE INVENTION

1. Field of the Invention

The invention relates to an optical polymer material usable for various kinds of coating materials such as electric wiring boards, machine component materials, antireflection films and surface protection films, optical communication devices such as optical transmitter and receiver modules and optical switches, optical devices of light propagation path structures such as an optical waveguide, an optical fiber/lens array and the like, and optical beam splitters comprising thereof, optical elements relevant to display devices (displays or liquid crystal projectors) such as integrator lens, micro-lens arrays, light reflectors, light guide plates and screens for projection, lenses such as spectacles lenses and lenses for optical systems for CCD, digital still cameras, cameras for mobile phones and the like, optical filters, diffraction grating, interferometers, optical integrators, optical multiplexers and branching filters, optical sensors, hologram optical devices, other optical component materials, photovoltaic devices, contact lenses, medical artificial tissues and molding materials of light emitting diodes (LED) and an optical component using the same.

2. Description of the Related Art

Glass or plastics have been employed mainly as materials for optical devices including lenses. Since there are many types of glass and the variations of optical characteristics are abundant, it is easy to carry out optical planning. Further, since the glass is an inorganic material, it is highly reliable. Further, it gives high precision optical devices by polishing.

However, the glass is high-cost and in the case of an aspherical shape other than plane or spherical shape, special polishing devices have to be used or so-called molding methods which involve molding glass materials deformable at a low temperature with costly and heat resistant dies (made of ceramics or the like) have to be employed and it leads to high production cost.

On the other hand, polymer materials are economical and lightweight and easy for processing and therefore they have been used widely as optical materials. However, polymer materials have low refractive indices and high Abbe numbers. To achromatize lens systems, combinations of materials with wide difference of Abbe numbers are required and polymer materials with high refractive indices and low Abbe numbers are required to achromatize in combination with common polymer materials having low refractive indices and high Abbe numbers.

Further, to obtain optical components with thin thickness as a whole by reducing the number of lenses, composite lenses are preferable. To carry out composite lens formation easily and highly precisely, radiation-curable type materials such as ultraviolet-curable resins and having low viscosity are desired.

Japanese Patent Application Laid-Open (JP-A) No. 4-325508 proposes, as radiation curable optical polymer materials with high refractive indices and low Abbe numbers, lens materials including fluorene compounds having two (meth)acryloyl groups and radical-polymerizable vinyl compounds.

However, in the case optical resin layers are formed using such lens materials and antireflection films are provided on the optical resin layers, there occurs a problem that the antireflection films are cracked in a heat shock test between −40° C. to 85° C. Further, there is also a problem that alteration of the refractive indices is significant under high temperature and high humidity.

JP-A 2005-162785 discloses resin compositions including fluorene compounds having four (meth)acryloyl groups and thermoplastic resins, however uses as optical polymer materials have not been discussed specifically.

### DISCLOSURE OF THE INVENTION

The object of the invention is directed to provide an optical polymer material having a low viscosity before curing, a high refractive index of a cured product, little alteration of refractive index under high temperature and high humidity, and an excellent heat resistant shock property and an optical component using thereof.

An optical polymer material of the invention is characterized in that the material contains a fluorene compound having four (meth) acryloyl groups and a (meth) acrylate having an aryl group. Aryl group includes a phenyl group, a phenylphenol group, a bisphenol group, a phthalic group, a naphthyl group and the like.

Since the optical polymer material of the invention contains a fluorene compound having four (meth) acryloyl groups and a (meth)acrylate having an aryl group, it has a low viscosity before curing, a high refractive index of a cured product, little alteration of refractive index under high temperature and high humidity, and an excellent heat resistant shock property. As compared with a fluorene compound having two (meth)acryloyl groups, a fluorene compound having four (meth)acryloyl groups can have an increased crosslinking density and may be provided with high material strength and therefore the heat resistant shock property is improved.

Use of a (meth)acrylate having phenylphenol group as the (meth) acrylate having an aryl group can further improve the effect in terms of high refractive index and suppression of the alteration of the refractive index under high temperature and high humidity. It is attributed to that the (meth)acrylate contains many benzene rings having a high refractive index and hydrophobicity.

Further, use of an organometallic polymer having a (meth) acryloyl, -M-O-M- bond (M is a metal atom), and an aryl group as the (meth)acrylate having an aryl group can more improve the effect in terms of suppression of the alteration of the refractive index under high temperature and high humidity.

Examples of the fluorene compound having four (meth)acryloyl groups may include compounds having the following structures.

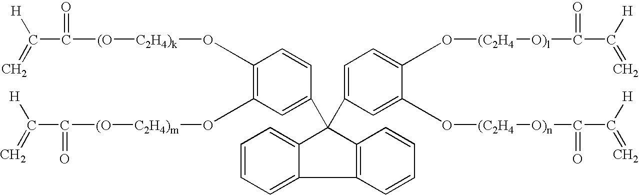

(In the above formula, k, l, m and n denote an integer of 0 to 5.)

With respect to the above compound, four acryloyl groups are contained in the compound, these acryloyl groups may be methacryloyl groups. In addition, in the invention, the (meth)acryloyl group is a generic term for an acryloyl group and a methacryloyl group. The (meth)acrylate is also a generic term for an acrylate and a methacrylate.

Further, the (meth) acrylate having a phenylphenol group in the invention is not particularly limited if it is a compound containing a phenylphenol group and a (meth) acryloyl group, and examples of the compound include the following compounds.

A hydroxyethylated o-phenylphenol acrylate (HEPPA) having the following structural formula.

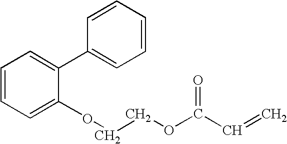

A hydroxyethylated o-phenylphenol methacrylate (HEPPMA) having the following structural formula.

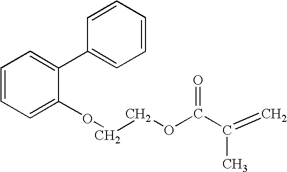

An o-Phenylphenol glycidyl ether acrylate having the following structural formula.

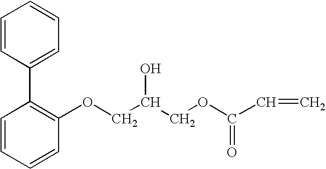

An o-Phenylphenyl acrylate having the following structural formula.

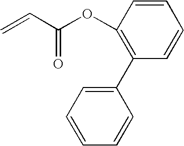

The optical polymer material of the invention may further contain an organometallic polymer having -M-O-M- bond (M is a metal atom) and an aryl group. Containing of such an organometallic polymer can further suppress alteration of the refractive indices under high temperature and high humidity. Containing of an organometallic polymer can also suppress curing shrinkage and thus improve the precision of a formation.

M in the -M-O-M- bond of the organometallic polymer is preferably at least one of Si, Nb, Ti, and Zr. M is particularly preferably Si.

The organometallic polymer in the invention can be synthesized by, for example, hydrolysis or polycondensation reaction of an organometal compound having at least two hydrolysable groups. In the case M is Si, examples of such an organometal compound include trialkoxysilane or dialkoxysilane having organic groups. Examples of the organic groups include an alkyl group, an aryl group, and an aryl-containing group. Use of an organometal compound having an aryl group or an aryl-containing group allows the aryl group to be introduced to the organometallic polymer. A phenyl group is preferable as an aryl group. Examples of an organometal compound having an phenyl group include phenyltrialkoxysilane and diphenyltrialkoxysilane and more specifically, phenyltriethoxysilane, phenyltrimethoxysilane, diphenyldimethoxysilane, and diphenyldiethoxysilane and the like.

Further, the above-mentioned organometal compound preferably contains organometal compounds having functional groups crosslinked by heating and/or energy beam radiation. Accordingly, bonds of molecules of an organometal compound can be formed by heating and/or energy beam radiation and at the same time, bonds of the organometallic polymer with the fluorene compound and the (meth)acrylate can be formed.

Energy beams may include ultraviolet rays, electron beams or the like. Examples of such crosslinkable functional groups are a (meth)acryloyl group, a styryl group, an epoxy group, a thiol group, and a vinyl group. Accordingly, trialkoxysilanes or dialkoxysilanes having these functional groups are preferably used. Specific examples of alkoxysilanes having a (meth)acryloyl group are 3-methacryloxypropylmethoxysilane, 3-methacryloxypropyltriethoxysilane, p-styryltrimethoxysilane, p-styryltriethoxysilane, 3-acryloxypropyltrimethoxysilane, 3-methacryloxypropylmethyldimethoxysilane, and 3-methacryloxypropylmethyldiethoxysilane. Examples of alkoxysilanes containing a vinyl group include vinyl triethoxysilane. Examples of alkoxysilanes containing a thiol group include 3-mercaptopropylmethyldimethoxysilane and 3-mercaptopropyltrimethoxysilane.

In the case a styryl group is used as a crosslinkable functional group, use of organometal compounds having styryl allows the aryl group to be introduced to the organometallic polymer.

The organometallic polymer having a (meth) acryloyl group can be used as the (meth)acrylate having an aryl group in the invention.

In the case an organometal compound having a crosslinkable functional group and an organometal compound having no functional group are used in a mixture, the mixing ratio is preferably 5 to 95: 95 to 5 (organometal compound having a functional group: organometal compound having no functional group) by weight.

The organometallic polymer is preferable to further contain an organic acid anhydride and/or an organic acid. Since an organic acid anhydride absorbs water and is hydrolyzed, containing of the organic acid anhydride can decrease water in the organometallic polymer. Accordingly, decrease of light absorption because of water or the change of form caused by evaporation of water can be suppressed.

The organic acid contained in the organometallic polymer promotes reaction of silanol groups or the like. Therefore, extinction of the silanol groups can be promoted. For example, reaction of silanol groups at molecular terminals in the organometallic polymer can be promoted. Further, a hydrolyzed product of a metal alkoxide having only one hydrolysable group is reacted with —OH groups formed at the terminals of the molecules of the organometal compound and thus the reaction of extinction of —OH group is promoted.

Specific examples of the above-mentioned organic acid anhydride include trifluoroacetic anhydride, acetic anhydride, propionic anhydride and the like. Particularly preferably, triflucroacetic anhydride is used. Specific examples of the above-mentioned organic acid include trifluoroacetic acid, acetic acid, propionic acid and the like. Particularly preferably, trifluoroacetic acid is used.

In the invention, if necessary, for the purpose of adjusting viscosity of a liquid before curing by energy radiation of heat, light or the like, mechanical characteristics such as hardness of a cured product, and optical characteristics such as refractive index and Abbe number, one functional, that is, a mono-functional (meth)acrylate may be added. Further, polyfunctional (meth)acrylate having a plurality of functional groups may be added.

Examples of mono-functional (meth)acrylate include, for example, benzyl (meth)acrylate, ethyl (meth)acrylate, methyl(meth)acrylate, isoboronyl (meth)acrylate, cyclohexyl (meth)acrylate, dicyclopentyl (meth)acrylate, α-naphthyl (meth)acrylate, β-naphthyl (meth)acrylate, dicyclopentenyloxyethyl (meth)acrylate, boronyl (meth)acrylate, phenyl (meth)acrylate, phenoxyethyl (meth)acrylate, phenoxypropyl (meth)acrylate, acryloyloxyethyl phthalate, cresol (meth)acrylate, p-cumylphenoxyethylene glycol (meth)acrylate, tribromophenyl (meth)acrylate, trimethylolpropanebenzoate (meth)acrylate, naphthyl (meth)acrylate and the like; and ethylene oxide (EO-modified) adducts, propylene oxide (PO-modified) adducts, and ethylcyclohexane (ECH-modified) adducts thereof.

Monofunctional (meth)acrylate having an aryl group can be used as the (meth)acrylate having an aryl group in the invention. Particularly, benzyl (meth)acrylate, phenoxyethyl (meth)acrylate, and the like having an aryl group and the viscosity of 20 mPa·s or lower at normal temperature and EO-, PO-, and ECH-modified products thereof are suitable since they have a relatively high refractive index and are effective to lower the viscosity. Further, methyl (meth) acrylate and butyl (meth)acrylate having the viscosity of 2 mPa·s or lower at normal temperature are effective to lower the viscosity although they have a relatively low refractive index.

Examples of polyfunctional (meth)acrylate include di-functional (meth)acrylate such as ethylene glycol di(meth)acrylate, propylene glycol di(meth)acrylate, polyethylene glycol di(meth)acrylate, polypropylene glycol di(meth)acrylate, 1,6-hexanediol di(meth)acrylate, glycerin di(meth)acrylate, di(meth)acrylate of 2,2-dimethyl-3-hydroxypropyl and 2,2-dimethyl-3-propionate, 1,4-butanediol di(meth)acrylate, neopentyl glycol di(meth)acrylate, di(meth)acrylate of hydroxypivalic acid neopentyl glycol, bisphenol A di(meth)acrylate, bisphenol F di(meth)acrylate, phthalic acid di(meth)acrylate, di(meth)acrylate of bisphenol A propylene oxide adduct, di(meth)acrylate of 2,2′-di(hydroxypropoxyphenyl)propane, di(meth)acrylate of 2,2′-di(hydroxyethoxyphenyl)propane, di(meth)acrylate of bisphenol A ethylene oxide adduct, di(meth)acrylate of tricyclodecanedimethylol, di(meth)acrylic acid adduct of 2,2′-di(glycidyloxyphenyl)propane and the like; moreover for example, pentaerythritol tri(meth)acrylate, pentaerythritol tetra(meth)acrylate, trimethylolpropane tri(meth)acrylate, dipentaerythritol hexa(meth)acrylate, trimellitic acid tri(meth)acrylate, triallyltrimellitic acid, triallyl isocyanurate, tri(meth)acrylate of tris(2-hydroxyethyl) isocyanurate, tri(meth)acrylate of tris(hydroxypropyl) isocyanurate, tetramethylolmethane tri(meth)acrylate, tetramethylolmethane tetra(meth)acrylate and the like.

The polyfunctional (meth)acrylates having an aryl group are also usable as the (meth)acrylate having an aryl group in the invention.

In the optical polymer material of the invention, the content of the fluorene compound is preferably in a range of 40 to 70% by weight. If the content of the fluorene compound is less than 40% by weight, the refractive index of a cured product becomes about 1.58 and it is sometimes impossible to obtain a high refractive index. If the content of the fluorene compound exceeds 70% by weight, the viscosity before curing cannot be lowered and no stable refractive index under high temperature and high humidity can be obtained in some cases.

Further, in the optical polymer material of the invention, the content of the (meth)acrylate having an aryl group is preferably 10 to 60% by weight. If the content of the (meth) acrylate is less than 10% by weight, it sometimes becomes difficult to simultaneously satisfy a high refractive index of a cured product and a low viscosity before curing. Further, if the content of the (meth) acrylate exceeds 60% by weight, the crosslinking density may be decreased to lower the material strength and the heat resistant shock property may become insufficient in some cases. In the case a plurality of types of (meth) acrylate are used as the (meth) acrylate having an aryl group, the content defined here is the total content.

Further, in the case no organometal compound is added, the content of the (meth)acrylate having an aryl group is further preferably in a range of 40 to 60% by weight.

In the case of containing the organometal compound, it is further preferably 5 to 40% by weight.

In the optical polymer material of the invention, in the case the organometal compound is contained, the content of the organometal compound is preferably in a range of 10 to 30% by weight. If the content of the organometal compound is less than 10% by weight, the effect obtained by the addition of the organometal compound, that is, the suppression of the alteration of the refractive index under high temperature and high humidity to low, cannot be caused sufficiently in some cases. Further, if the content of the organometal compound exceeds 30% by weight, the stability of the refractive index under high temperature and high humidity cannot be obtained in some cases. The content of the organometal compound is further preferably in a range of 10 to 20% by weight.

In the optical polymer material of the invention, in the case the monofunctional (meth)acrylate is contained, the content of the monofunctional (meth) acrylate is preferably 25% by weight or lower. If the content of the monofunctional (meth)acrylate exceeds 25% by weight, the refractive index of a cured product becomes about 1.58 and it is sometimes impossible to obtain a high refractive index. The content of the monofunctional (meth)acrylate is further preferably in a range of 5 to 15% by weight. If the content of the monofunctional (meth) acrylate is less than that, the viscosity before curing become high and if exceeds, the heat resistant shock property is lowered in some cases.

In the optical polymer material of the invention, in the case the polyfunctional (meth)acrylate is contained, the content of the polyfunctional (meth) acrylate is preferably 15% by weight or lower. If the content of the polyfunctional (meth)acrylate exceeds 15% by weight, the refractive index of a cured product becomes about 1.58 and it is sometimes impossible to obtain a high refractive index. The content of the polyfunctional (meth)acrylate is further preferably in a range of 2 to 6% by weight. If the content of the polyfunctional (meth) acrylate is less than that, the range of refractive index adjustment is narrowed and if exceeds, refractive index is lowered and therefore it is required to increase the amount of the fluorene compound and accordingly it may lead to increase the viscosity.

In the optical polymer material of the invention, it is preferable to contain a radical polymerization initiator.

Examples of the radical polymerization initiator include 1-hydroxy-cyclohexyl-phenyl-ketone, 2-hydroxy-2-methyl-1-phenyl-propan-1-one, 2-benzyl-2-dimethylamino-1-(4-morpholinophenyl)-butanone-1, oxyphenyl-acetic acid 2-[2-oxo-2-phenyl-acetoxy-ethoxy]-ethyl ester, oxy-phenyl-acetic acid 2-[2-hydroxy-ethoxy]-ethyl ester, 2-methyl-1-(4-methylthiophenyl)-2-morpholinopropan-1-one, 2-hydroxy-1-{4-[4-(2-hydroxy-2-methyl-propionyl-benzyl)phenyl]-2-methyl-propan-1-one and mixtures thereof.

The content of the radical polymerization initiator is preferably 0.5 to 3 components by weight to 100 parts by weight of all of components contained in the optical polymer material other than the radical polymerization initiator. If the content of the radical polymerization initiator is less than that, curing sometimes becomes difficult. Further, if it is higher than the range, the cured product becomes yellowish in some cases.

The optical polymer material of the invention may contain an antioxidant, a light stabilizer such as HALS (Hindered Amine Light Stabilizer), an ultraviolet absorbent, or the like.

An optical component of the invention is characterized in that it is obtained by curing the above-mentioned optical polymer material of the invention to form a light transmitting region.

Specific examples of the optical component of the invention include those obtained by forming a light transmitting region using the optical polymer material of the invention on a mother material such as a translucent glass, ceramic, or plastic. In the case a plastic is used as the mother material, a mother material including a cycloolefin type resin is preferably used since it is excellent in humidity resistance and the like.

Examples of the optical component of the invention may include composite type optical devices such as a composite type aspherical lens and the like, and an optical waveguide including a core layer and/or a clad layer formed using the optical polymer material. The composite type aspherical lens is those obtained by forming a light transmitting region including a translucent resin layer on spherical lens made of glass, a plastic or the like and making it aspherical lens.

A coating layer including a metal oxide may be formed on the light transmitting resin. Such a coating layer can be formed as a antireflection film.

An optical apparatus of the invention is characterized in that it is provided with the above-mentioned optical component of the invention. As the optical apparatus, a camera module having a composite type aspherical lens can be exemplified. Such a camera module can be used for mobile phones and vehicular back monitors.

Examples of the optical apparatus of the invention include optical communication devices such as optical switches, optical transmitter and receiver modules, and optical couplers; display apparatus such as liquid crystal devices, plasma displays, organic EL displays, projectors such as liquid crystal projectors, cinema projectors and the like; image pickup modules such as cameras, e.g. digital cameras, image pickup apparatus, e.g. video cameras, CCD camera modules, CMOS camera modules and the like; and optical appliances such as telescopes, microscopes, and magnifying glass and the like.

The optical polymer material of the invention contains a fluorene compound having four (meth)acryloyl groups and a (meth)acrylate having an aryl group and has a low viscosity before curing, a high refractive index of a cured product, little alteration of refractive index under high temperature and high humidity, and an excellent heat resistant shock property.

### BRIEF DESCRIPTION OF THE DRAWINGS

FIG. 1 is a schematic cross-sectional view showing a composite type aspherical lens, an optical component of the invention;

FIG. 2 is a drawing showing a relation of mixing ratio of an organometallic polymer and a refractive index alteration of a cured product of the optical polymer material under high temperature and high humidity;

FIG. 3 is a drawing showing a relation of the additive amount of TMPTA and the refractive index of a cured product of the optical polymer material;

FIG. 4 is a schematic cross-sectional view of an apparatus employed for a heat shock test carried out in Examples of the invention;

FIG. 5 is a drawing showing intervals of a thermostat bath at 85° C. and a thermostat bath at −40° C. in the heat shock test;

FIG. 6 is a schematic cross-sectional view showing one example of a conventional camera module;

FIG. 7 is a schematic cross-sectional view showing a camera module in embodiments according to the invention;

FIG. 8 is a schematic cross-sectional view showing an folio type mobile phone;

FIG. 9 is a schematic cross-sectional view showing an optical waveguide of one embodiment according to the invention;

FIG. 10 is a schematic cross-sectional view showing an optical waveguide of another embodiment according to the invention;

FIG. 11 is a schematic cross-sectional view showing an optical waveguide of further another embodiment according to the invention;

FIG. 12 is a schematic cross-sectional view showing a liquid crystal projector of one embodiment;

FIG. 13 is a schematic cross-sectional view showing a liquid crystal projector of one embodiment according to the invention;

FIG. 14 is a schematic cross-sectional view showing a liquid crystal projector of another embodiment according to the invention; and

FIG. 15 is a schematic cross-sectional view showing an optical transmitter and receiver module of one embodiment according to the invention.

### DETAILED DESCRIPTION OF THE PREFERRED EMBODIMENTS

Hereinafter the invention will be described more in detail with reference to examples, however the invention should not be limited to the following examples.

### [Preparation of Organometallic Polymer]

Organometallic polymers used in the following Examples and Comparative Examples were prepared in the following manner.
(1) 12.26 ml of diphenyldimethoxysilane (DPhDMS) and 10.32 ml of 3-methacryloxypropyltriethoxysialne (MPTES) were added to 40.0 ml of ethanol and while the mixture was stirred, 3.80 ml of 2N hydrochloric acid was dropwise added.
(2) The above-mentioned solution (1) was heated to remove ethanol.
(3) To the above-mentioned product (2), 10 ml of trifluoroacetic anhydride was injected and stirred.
(4) The above-mentioned solution (3) was heated to remove trifluoroacetic anhydride.
(5) After 37.5 ml of trimethylethoxysilane was injected and stirred, the mixture was heated to remove trimethylethoxysilane to obtain an organometallic polymer solution.

### EXAMPLE 1

As a fluorene compound having four (meth) acryloyl groups, (9,9′-bis[3,4-di-(2-hydroxyethoxy)phenyl]fluorene tetraacrylate), a compound having a chemical structure defined by the above-mentioned general formula wherein any of k, l, m and n denote 1 was used. In Table 1, this fluorene compound is shown as “tetrafunctional fluorene”. Further, as a (meth)acrylate having a phenylphenol group, hydroxyethylated o-phenylphenol methacrylate (HEPPMA) was used.

As shown in Table 1, 50% by weight of HEPPMA was added to 50% by weight of tetrafunctional fluorene and 1 component by weight of 1-hydroxy-cyclohexyl-phenyl-ketone as a polymerization initiator was added to in total 100 components by weight of the tetrafunctional fluorene and HEPPMA and the mixture was heated and shaken at 100° C. to produce a resin composition of Example 1. In the following respective Examples and Comparative Examples, a polymerization initiator was added in an amount of 1 component by weight to the total of the monomers.

[Density of (meth)acryloyl Group]

The density of a (meth)acryloyl group is calculated from known chemical structure and physical property values such as density and shown in Table 1. In addition, the crosslinking density is the product of (meth)acryloyl density and polymerization degree and the polymerization degree can be measured by as follows. A (meth) acryloyl group has a C—C double bond and since curing is caused by opening the double bond and bonding with another (meth)acryloyl group, the amounts of C—C double bonds before and after curing by IR spectroscopy were compared. As a result, if the sample shape, the additive amount of a polymerization initiator, and ultraviolet radiation satisfied the conditions as described below, the polymerization degree was about 60% regardless of the mixing ratio.

### [Measurement of Viscosity Before Curing]

The viscosity of a resin composition before curing was measured at 23° C. and the result is shown in Table 1.

### [Measurement of Refractive Index of Cured Product]

The above-mentioned resin composition was sandwiched between quartz glass plates of 1 mm thick and ultraviolet rays with about 30 mW/cm² intensity and mean wavelength of 365 nm were radiated from an ultraviolet lamp for 15 minutes to cure the composition. The refractive index of the cured product was measured. The result is shown in Table 1.

### [Measurement of Refractive Index Alteration Under High Temperature and High Humidity]

The above-mentioned high temperature and high humidity test was carried out by leaving the above-mentioned sample for refractive index measurement in high temperature and high humidity of 60° C. temperature and 90% humidity for 500 hours. The test result is shown in Table 1.

### [Production of Composite Type Aspherical Lens]

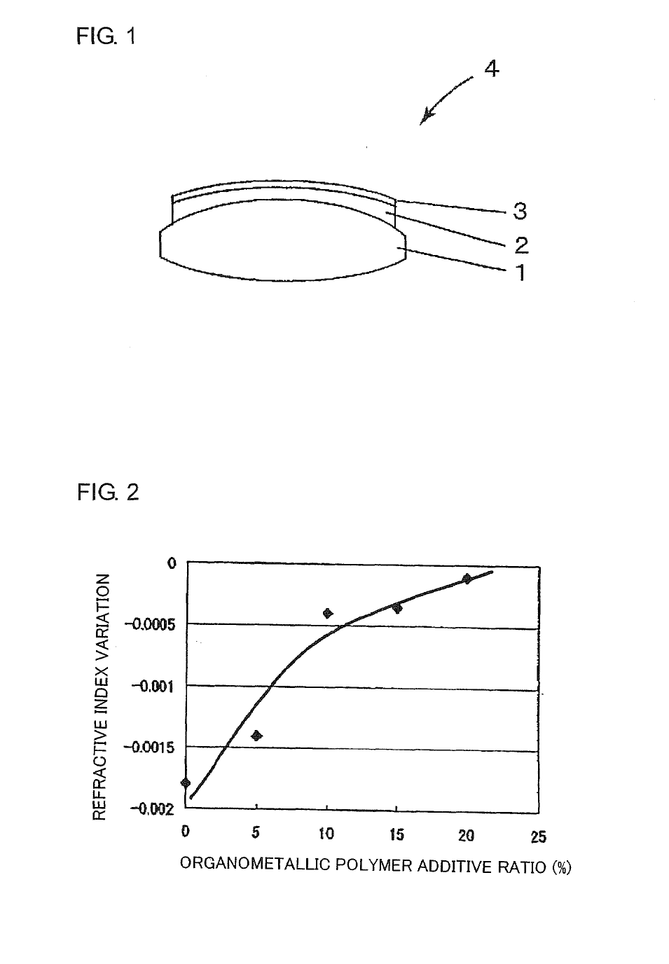

A composite type aspherical lens as shown in FIG. 1 was produced.

In the composite type aspherical lens 4 shown in FIG. 1, an optical resin layer 2 was formed on a lens mother material 1 and a nonreflecting coating film 3 was formed on the optical resin layer 2. As the lens mother material 1, a lens mother material including a cyclic olefin resin (trade name: ZEONEX, manufactured by Zeon Corporation) was employed and the optical resin layer 2 was molded with dies on the lens mother material 1 using the above-mentioned resin composition. The above-mentioned resin composition was dropped on the lens mother material 1 and the resin composition was pressurized from the upper side by the die and in such a state, ultraviolet irradiation was carried out from the opposed side of the lens mother material 1 to cure the resin composition and accordingly form the optical resin layer 2. The ultraviolet irradiation was carried out with 300 mW/cm² intensity and the irradiation time for 2 minutes by irradiating mainly ultraviolet with wavelength of 365 nm.

After forming the optical resin layer 2 in the above-mentioned manner, a nonreflecting coating film 3 including a titanium oxide film and a silicon oxide film was formed on the optical resin layer 2 by electron beam deposition method. The nonreflecting coating film 3 (AR film) was formed by reciprocally laminating the titanium oxide film and silicon oxide film by the electron beam deposition method. The designed wavelength λ was set to be 500 nm and the silicon oxide film with a film thickness of λ, the titanium oxide film with a film thickness of 0.04 λ, the silicon oxide film with a film thickness of 0.1 λ, the titanium oxide film with a film thickness of 0.5 λ, and the silicon oxide film with a film thickness of 0.24 λ were laminated from the lens mother material 1 side to form the nonreflecting coating film.

The thickness of the center portion of the lens mother material 1 was 1.7 mm and the thickness of the center portion of the optical resin layer 2 was 260 μm.

### [Test of Heat Shock]

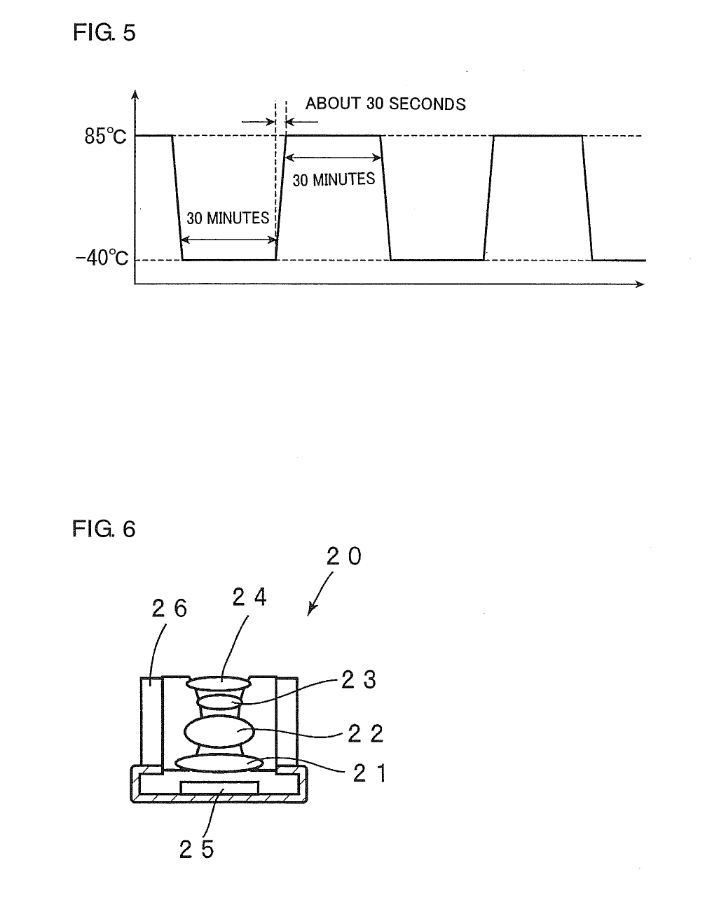

With respect to the composite type aspherical lens produced in the above-mentioned manner, a heat shock test was carried out. FIG. 4 is a schematic cross sectional view showing the apparatus employed for the heat shock test. A sample 8 of an object to be measured was set in a container 7 and the container 7 was reciprocated between a thermostat bath 5 at −40° C. and a thermostat bath 6 at 85° C. in cycles shown in FIG. 5 to give heat shock to the sample 8.

The result of the heat shock test is shown in Table 1. In Table 1, “60 or less” means that cracks were formed in the nonreflecting coating film when observed after 60 cycles in the case where making leaving at the above-mentioned −40° C. for 30 minutes and leaving at 85° C. for 30 minutes as 1 cycle. In addition, “250 or more” means that no crack was formed in the nonreflecting coating film when observed after 250 cycles.

### EXAMPLE 2

As shown in Table 1, a resin composition was prepared in the same manner as Example 1 by mixing 70% by weight of the tetrafunctional fluorene, 5% by weight of the organometallic polymer, and 25% by weight of phenoxyethyl acrylate (PhEA) with the same polymerization initiator as that in Example 1.

A sample for refractive index measurement and a sample for heat shock test were produced in the same manner as Example 1 and the viscosity before curing, the refractive index of the cured product, the alteration of the refractive index under high temperature and high humidity, and the result of the heat shock test are shown in Table 1.

### EXAMPLE 3

As shown in Table 1, a resin composition was prepared in the same manner as Example 1 by mixing 45% by weight of the tetrafunctional fluorene, 14% by weight of the organometallic polymer, 22% by weight of hydroxyethylated o-phenylphenol acrylate (HEPPA), and 19% by weight of phenoxyethyl acrylate (PhEA) with the same polymerization initiator as that in Example 1.

A sample for refractive index measurement and a sample for heat shock test were produced in the same manner as Example 1 and the viscosity before curing, the refractive index of the cured product, the alteration of the refractive index under high temperature and high humidity, and the result of the heat shock test are shown in Table 1.

### EXAMPLE 4

As shown in Table 1, a resin composition was prepared in the same manner as Example 1 by mixing 52% by weight of the tetrafunctional fluorene, 14% by weight of the organometallic polymer, 22% by weight of HEPPA, 8% by weight of PhEA, and 4% by weight of trimethylolpropane triacrylate (TMPTA) with the same polymerization initiator as that in Example 1.

A sample for refractive index measurement and a sample for heat shock test were produced using the resin composition in the same manner as Example 1 and the test results are shown in Table 1.

### EXAMPLE 5

As shown in Table 1, a resin composition was prepared in the same manner as Example 1 by mixing 70% by weight of atetrafunctional fluorene, and 30% by weight of PhEA with the same polymerization initiator as that in Example 1.

A sample for refractive index measurement and a sample for heat shock test were produced using the resin composition and measurements were carried out. The test results are shown in Table 1.

### COMPARATIVE EXAMPLE 1

As a fluorene compound, 4,4′-(9-fluorenylidene) bis(2-phenoxyethylacrylate) having the following chemical structure (m and n are 1) was used. Hereinafter, this fluorene compound is referred to as “bifunctional fluorene”.

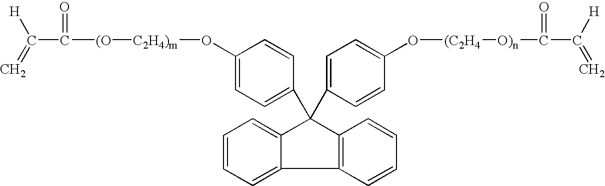

As shown in Table 1, a resin composition was prepared in the same manner as Example 1 by mixing 70% by weight of the bifunctional fluorene, and 30% by weight of PhEA with the same polymerization initiator as that in Example 1.

A sample for refractive index measurement and a sample for heat shock test were produced using the resin composition in the same manner as described above and the test results are shown in Table 1.

### COMPARATIVE EXAMPLE 2

As shown in Table 1, a resin composition was prepared by mixing 44% by weight of the bifunctional fluorene, 24% by weight of the organometallic polymer, 20% by weight of HEPPMA, and 12% by weight of pentaerythritol triacrylate (PETA) with the same polymerization initiator as described above.

A sample for refractive index measurement and a sample for heat shock test were produced using the resin composition and measurements were carried out. The test results are shown in Table 1.

TABLE 1

| | Blending Ratio (% by Weight) | | | | | | | |
|---|---|---|---|---|---|---|---|---|
| | Bifunctional | Tetrafunctional | Organometal | | | | | |
| | Fluorene | Fluorene | Polymer | HEPPMA | HEPPA | PhEA | PETA | TMPTA |
| Ex. 1 | — | 50 | — | 50 | — | — | — | — |
| Ex. 2 | — | 70 | 5 | — | — | 25 | — | — |
| Ex. 3 | — | 45 | 14 | — | 22 | 19 | — | — |
| Ex. 4 | — | 52 | 14 | — | 22 | 8 | — | 4 |
| Ex. 5 | — | 70 | — | — | — | 30 | — | — |
| Comp. | 70 | — | — | — | — | 30 | — | — |
| Ex. 1 | | | | | | | | |
| Comp. | 44 | — | 24 | 20 | — | — | 12 | — |
| Ex. 2 | | | | | | | | |

| | | Characteristics | | | |
|---|---|---|---|---|---|
| | | Viscosity | | Refractive Index | |
| | (Meth) Acryloyl | before | | Variation under | |
| | Group Density | Curing | Refractive | High Temperature | |
| | (mol/g) | (P · s) | Index | and High Humidity | Heat Shock |
| Ex. 1 | 0.0042 | 8 | 1.604 | 0.0010 or Less | 250 or More |
| Ex. 2 | 0.0048 | 9 | 1.592 | 0.0015 | 250 or More |
| Ex. 3 | 0.0043 | 7 | 1.593 | 0.0010 or Less | 250 or More |
| Ex. 4 | 0.0045 | 9 | 1.593 | 0.0010 or Less | 250 or More |
| Ex. 5 | 0.0049 | 6 | 1.593 | 0.0018 | 250 or More |
| Comp. | 0.0039 | 5 | 1.606 | Not Measured | 60 or Less |
| Ex. 1 | | | | | |
| Comp. | 0.0041 | 30 or More | 1.594 | 0.0010 or Less | 250 or More |
| Ex. 2 | | | | | |

As shown in Table 1, in Examples 1 to 5 according to the invention, the viscosity of the liquids before curing is low and the alteration of the refractive index under high temperature and high humidity is slight and the heat resistant shock property is also good. In general, at the time of using a resin and another material with a quite different thermal expansion coefficient by bonding, it is known that decrease of the modulus of elasticity of the resin is effective and a method of decreasing the crosslinking density of the resin is known to be effective for decreasing the modulus of elasticity of the resin.

However, as shown in Table 1, Comparative Example 1 with low (meth)acryloyl group density is inferior in the heat resistant shock property. It is supposedly attributed to that since the hard and fragile nonreflecting coating film including the inorganic oxide is formed on the resin layer, when the modulus of elasticity of the resin layer is decreased, the resin layer is deformed due to the difference of the thermal expansion coefficient and the nonreflecting coating film is cracked because of that. Accordingly, as the Examples, in the case a plastic is used as the mother material and a coating layer including a metal oxide is formed on a light transmitting region (resin layer), the (meth)acryloyl group density in the resin layer is preferable to be high and it is preferably 0.004 mol/g or higher.

Further, the polymerization degree of the (meth) acryloyl group is preferably 60% or higher and accordingly the crosslinking density of the (meth)acryl bond is preferably 0.0024 mol/g or higher.

As being made clear by comparison of Comparative Example 1 and Example 5, use of tetrafunctional fluorene in place of bifunctional fluorene can increase heat resistant shock property. According to the invention, use of the (meth) acrylate having an aryl group can decrease the alteration of the refractive index under high temperature and high humidity.

Comparative Example 2 shows a blending example with low refractive index alteration under high temperature and high humidity and excellent heat resistant shock property in the case of using the bifunctional fluorene. To lower the viscosity before curing while keeping the refractive index, a large amount of HEMPA is added, however the viscosity before curing is 30 P·s or more.

### <Discussion of Mixing Ratio of Organometallic Polymer>

FIG. 2 is a drawing showing the refractive index alteration under high temperature and high humidity in the case the blending ratio of the organometallic polymer is changed.

As shown in Table 2, the resin compositions were prepared with the blending ratio of the organometallic polymer changed to be 0% by weight, 5% by weight, 10% by weight, 15% by weight, and 20% by weight. The resin compositions were prepared in the same manner as Example 1, except blending composition ratios were changed as shown in Table 2.

In the same manner as the above-mentioned Examples, samples for refractive index measurement were produced and the high temperature and high humidity test was carried out to measure the refractive index alteration under high temperature and high humidity. FIG. 2 shows the results of this test. As shown in FIG. 2, the refractive index alteration under high temperature and high humidity can be adjusted by adjusting the blending ratio of the organometallic polymer.

TABLE 2
Blending Ratio (% by Weight)

| Tetrafunctional | Organometallic | | | |
|---|---|---|---|---|
| Fluorene | polymer | HEPPMA | HEPPA | PhEA |
| 70 | — | — | — | 30 |
| 45 | 5 | 42 | — | 8 |
| 51 | 10 | 31 | — | 8 |
| 55 | 15 | — | 25 | 10 |
| 62 | 20 | 10 | — | 8 |

### <Discussion of TMPTA Addition>

The effect of additive amount of TMPTA on the refractive index of a cured product was investigated by additionally adding TMPTA to the resin composition of Example 4.

As shown in FIG. 5, TMPTA was added in an amount of 1.0% by weight, 2.0% by weight, and 3.0% by weight to 100 components by weight of the resin composition excluding the polymerization initiator and the refractive index of the cured product of the respective resin composition was measured.

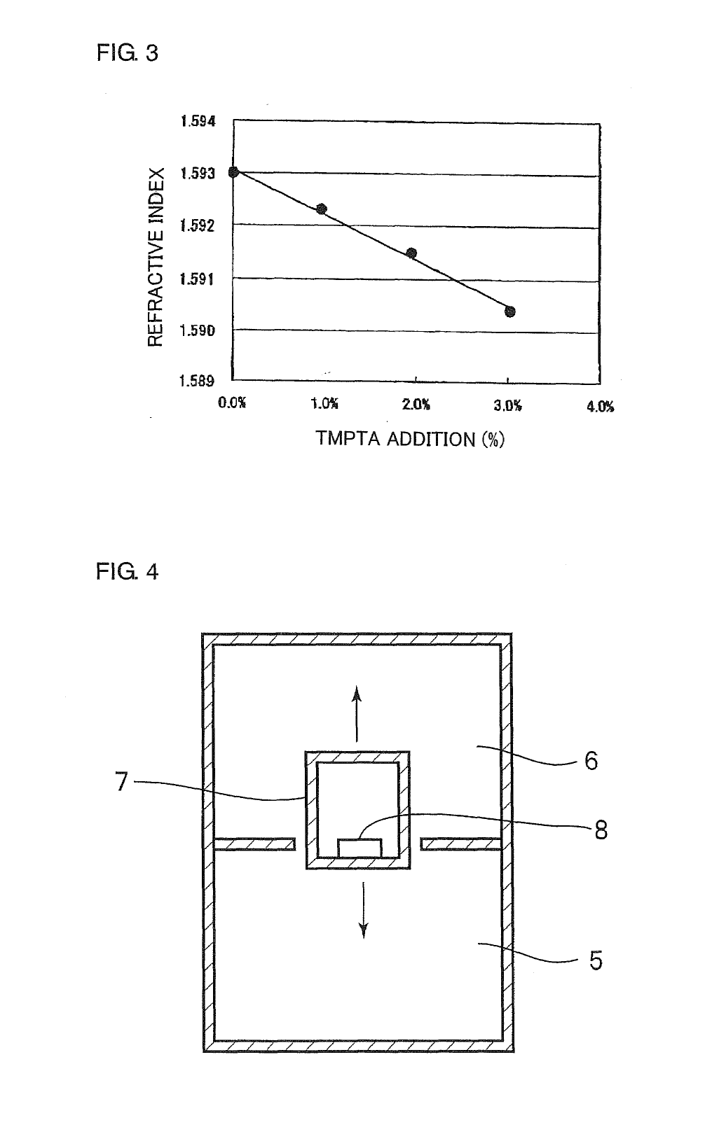

As shown in FIG. 3, addition of TMPTA can decrease the refractive index of a cured product. Accordingly, the refractive index of a cured product can be adjusted by adjusting the additive amount of TMPTA. Further, even if the additive amount of TMPTA is increased, the crosslinking density is increased and therefore, the heat resistant shock property becomes better.

### APPLICATION EXAMPLE 1

FIG. 6 is a cross sectional view showing one example of a conventional camera module. As shown in FIG. 6, two plastic aspherical lenses 21 and 22 and two glass spherical lenses 23 and 24 are provided on an image pickup device 25 and these lenses are held by an auto-focusing mechanism 26. The camera module 20 includes these four lenses 21 to 24 and can be employed as a camera module with 2 to 5 mega pixels for mobile phones. A needed magnification can be attained and simultaneously various aberration corrections including chromatic aberration indispensable for lenses for image photographing cameras are conducted by combining a plurality of lenses. For example, in the instance shown in FIG. 6, it is designed to offset the chromatic aberration by setting Abbe number of at least one of the spherical lenses 23 and 24 to be high and setting Abbe number of at least one of the plastic aspherical lenses 21 and 22 to be low.

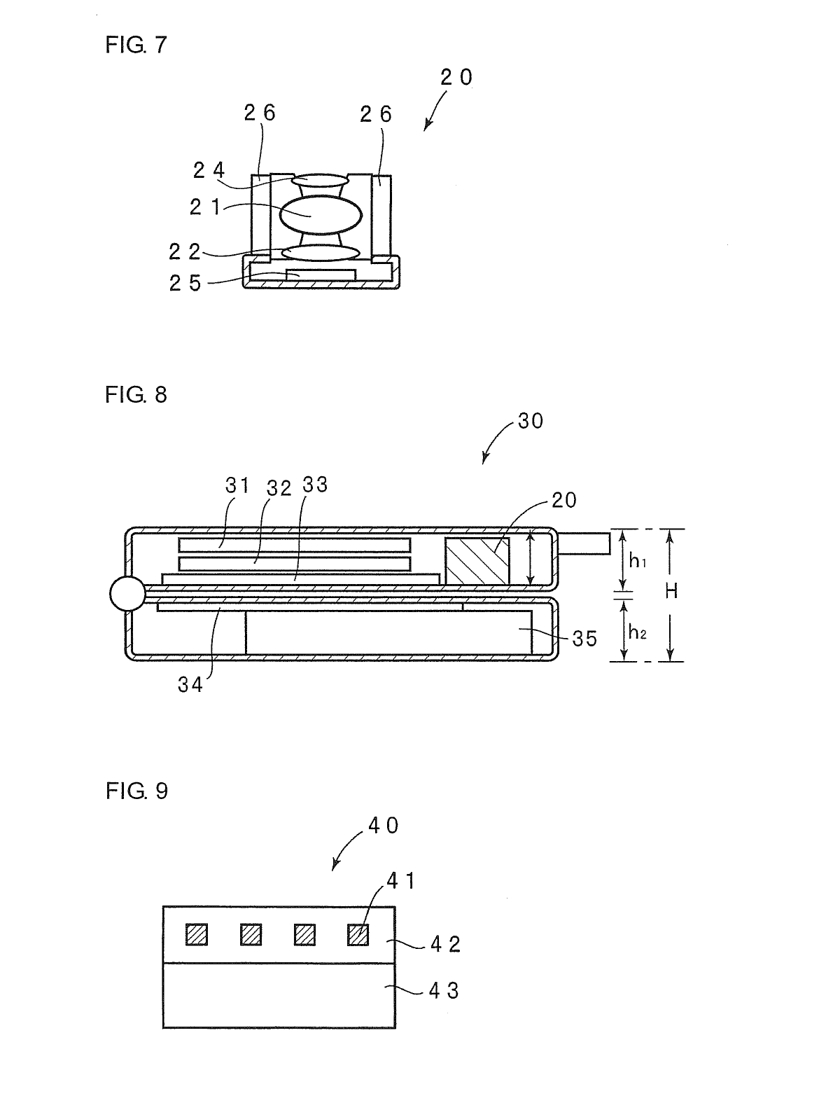

FIG. 7 is a cross-sectional view showing a camera module of an example according to the invention. In FIG. 7, a composite type aspherical lens (refractive index of an optical resin layer: about 1.59, Abbe number: about 30) of the invention is employed for either one of the lenses 23 and 24 in FIG. 6, so that it can be made possible to carry out the chromatic aberration correction by the optical resin layer with small Abbe number and at least one of the plastic aspherical lenses 21 and 22 and one lens can be eliminated. As a result, the height of the camera module can be lowered by about 1 mm. The height of the conventional camera module shown in FIG. 6 is about 10 mm and the height of the camera module of the present example shown in FIG. 7 is about 9 mm.

FIG. 8 is a cross-sectional view showing an folio type mobile phone. A camera module 20 is installed in an upper part of the mobile phone and a TV tuner 31, a hard disk drive 32, and a display 33 are embedded. A keyboard 34, a battery 35 and the like are embedded in a lower part of the mobile phone.

In the case a conventional camera module is used as the camera module 20, the height h₁ of the upper part and the height h₂ of the lower part of the mobile phone become 12.5 mm, respectively, and the total height of the mobile phone H becomes 25 mm. However, according to the invention, use of the camera module of the example shown in FIG. 7 as the camera module 20 can make the height h₁ thinner by about 1 mm and accordingly the entire height H can also be made thinner by about 1 mm.

### APPLICATION EXAMPLE 2

The camera module shown in FIG. 7 can also be used as a camera module for vehicular back monitors. With respect to a vehicular camera module, a highly advanced heat resistance is required and the aspherical lens of the invention can be used. Further, since the aspherical lens of the invention has a high refractive index, the view angle can be widened.

### APPLICATION EXAMPLE 3

The optical polymer material of the invention can be used for wiring in substrates or wiring between substrates of various kinds of electronic appliances and is also applicable for optical waveguide devices.

FIG. 9 is a cross-sectional view showing an example of an optical waveguide of the invention. As shown in FIG. 9, a clad layer 42 is provided on a plastic substrate 43 and core layers 41 are formed in the clad layer 42. The height of the core layers 41 are about 70 μm and the distance between the core layers is about 500 μm. On the core layers 41, the clad layer 42 with a thickness about 100 μm exists and under the core layers 41, the clad layer 42 with a thickness of about 100 μm also exists.

In this example, the core layers 41 are formed using a material adjusted to have a refractive index of about 1.60 in form of a solid after photo-curing. Further, the clad layer 42 is formed using a material adjusted to have a refractive index of about 1.58. The cross section of the core layers 41 is about 70 μm square. Moreover, a ZEONEX substrate with a thickness of 1 mm is used as the plastic substrate 43.

When the light with wavelength of 650 nm, 830 nm, and 850 nm were inlet from the face of one side of the optical waveguide, it was confirmed that the respective lights came out from the face of another side. When the light propagation loss was measured by a cut-back method, it was 0.5 dB/cm or less.

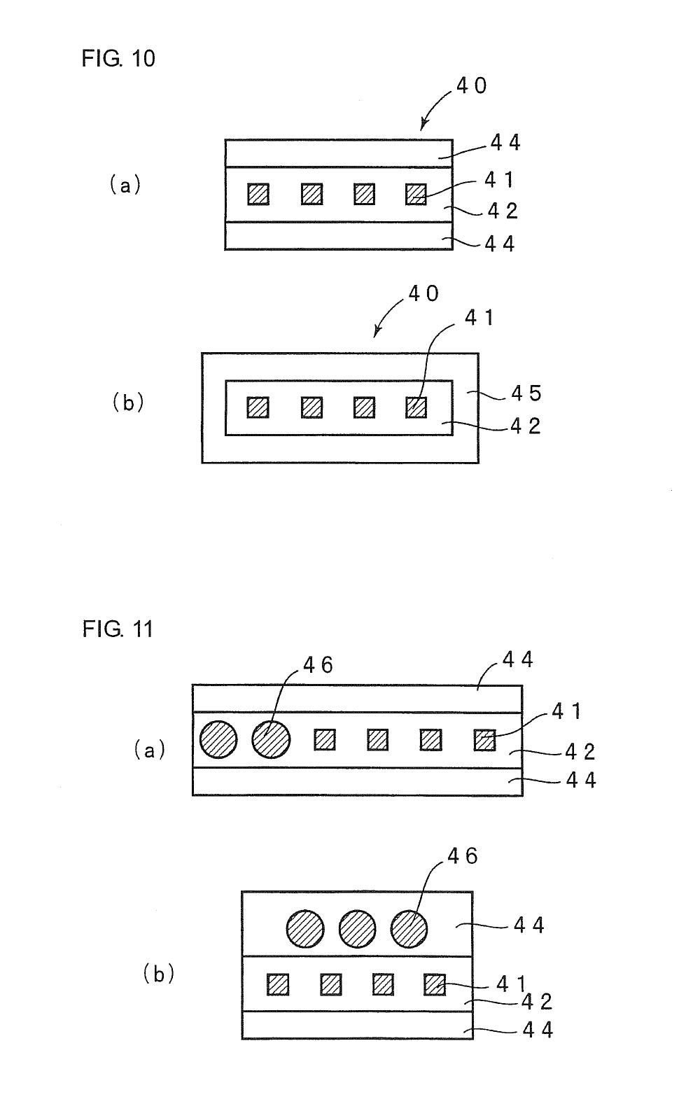

FIG. 10(a) is a drawing showing an optical waveguide with a structure formed by sandwiching both sides of the core layers 41 and clad layer 42 shown in FIG. 9 with a polyimide film 44 in a thick of 70 μm, which is a flexible substrate.

Further, FIG. 10(b) is a cross-sectional view showing an optical waveguide forming a mold layer 45 by molding the surrounding of the clad layer 42 with a polyimide in a thickness of 70 μm.

As shown in FIG. 10(a) and FIG. 10(b), in the case a flexible substrate is used, it was possible to bend the substrate to a curvature radium of about 10 mm.

FIG. 11 is a cross-sectional view showing another example of an optical waveguide according to the invention.

In FIG. 11(a), a copper wiring 46 for electric power with a diameter of 150 μm is provided with one side of the core layers 41. Both sides of the clad layer 42 are sandwiched with a polyimide film 44 in a thick of 70 μm, which is a flexible substrate.

In the example of FIG. 11(b), a copper wiring 46 for electric power is arranged in the upper polyimide film 44.

As shown in FIG. 11, in the optical waveguide of the invention, a wiring for electric power may be provided. By providing of the wiring for electric power, it is possible to carry out a supply of information signals and electric power only with one single device.

The copper wiring 46 for electric power may have a rectangular cross sectional shape.

### APPLICATION EXAMPLE 4

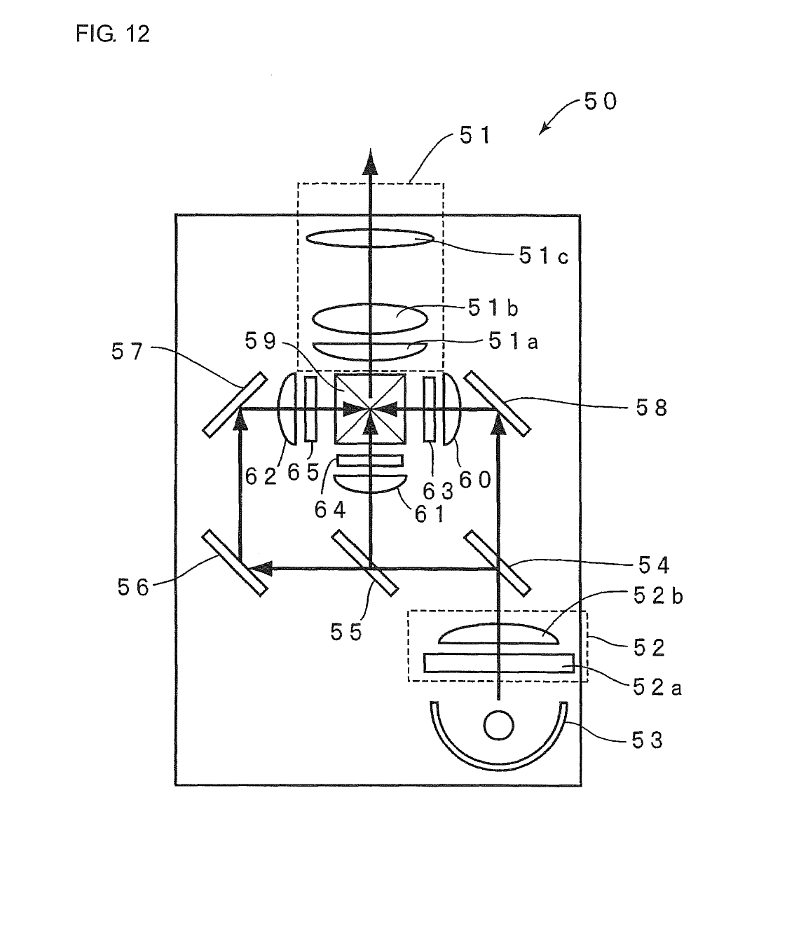

FIG. 12 is a schematic cross-sectional view showing a liquid crystal projector. An illuminating optical system 52 is provided on a light source 53 and the illuminating optical system 52 includes lenses 52a and 52b. The light radiated from the light source 53 collides to a half mirror 54 and the light transmitted through the half mirror 54 is reflected by a mirror 58 and passes through a lens 60 and a liquid crystal panel 63 and enters in a cross prism 59.

On the other hand, the light reflected by the half mirror 54 is irradiated to a half mirror 55 and the light reflected by the half mirror 55 passes through a lens 61 and a liquid crystal panel 64 and enters in the cross prism 59.

The light transmitted through the half mirror 55 is reflected by a mirror 56 and further reflected by a mirror 57 and passes through the lens 61 and the liquid crystal panel 64 and enters in the cross prism 59.

The liquid crystal panel 65 is a liquid crystal panel for red (R); the liquid crystal panel 64 is a liquid crystal panel for green (G); and the liquid crystal panel 63 is a liquid crystal panel for blue (B). The light passes these liquid crystal panels are combined at the cross prism 59 and passes through in a projection optical system 51 and is radiated outside. The projection optical system 51 includes lenses 51a, 51b, and 51c.

The light source 53 includes, for example, a metal halide lamp, a mercury lamp, LED or the like.

Since the light source 53 is a heat generation source, conventionally lenses 51a to 51c of the projection optical system 51 had to be set apart from a certain distance from the light source 53.

However, the optical component of the invention is formed from the optical polymer material having good heat resistance as described above, it can be set close to the light source 53.

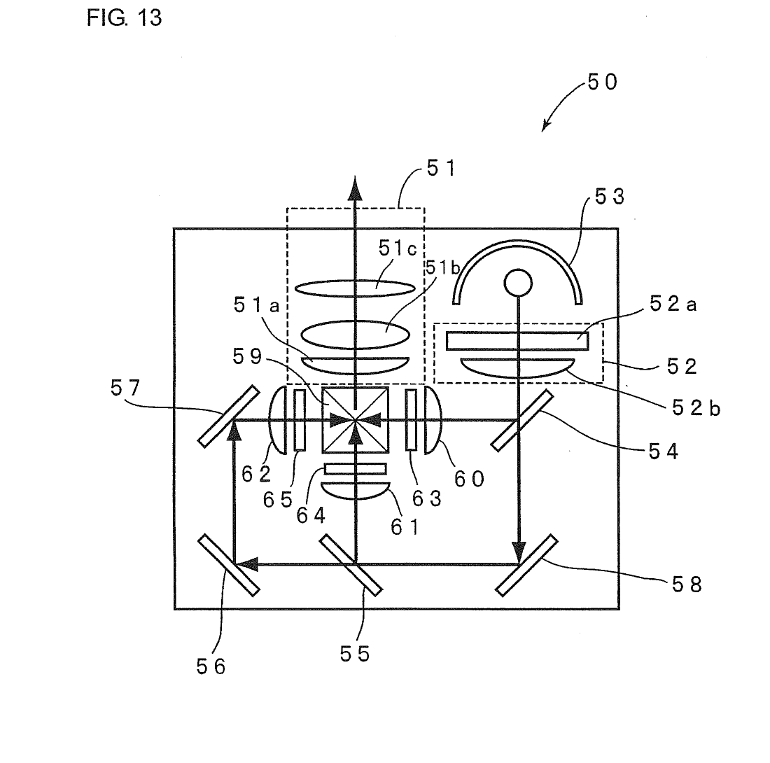

FIG. 13 is a schematic cross-sectional view showing one example of a liquid crystal projector according to the invention.

In the example shown in FIG. 13, the lens of Example 9 is used for lenses 51a to 51c of the projection optical system 51. Therefore, as shown in FIG. 13, the position of the light source 53 can be set close to the projection optical system 51. Accordingly, the liquid crystal projector 50 can be miniaturized.

In the liquid crystal projector shown in FIG. 13, the light radiated from the light source 53 passes through the illuminating optical system 52 and is irradiated to a half mirror 54 and the light reflected by the half mirror 54 passes through a lens 60 and a liquid crystal panel 63 and enters in a cross prism 59. The light transmitted through the half mirror 54 is reflected by a mirror 58 and proceeds to a half mirror 55. The light reflected by the half mirror 55 passes through a lens 61 and a liquid crystal panel 64 and enters in the cross prism 59. The light transmitted through the half mirror 55 is reflected by a mirror 56 and further reflected by a mirror 57 and passes through a lens 62 and a liquid crystal panel 65 and enters in a cross prism 59. The light transmitted through these liquid crystal panels 63, 64, and 65 are combined at the cross prism 59 and passes through in a projection optical system 51 and is radiated outside.

The liquid crystal projectors shown in FIG. 12 and FIG. 13 are three plate type transmission projectors for displaying RGB by independent liquid crystal panels and the same effect can be obtained in a single plate type transmission type projector using a single liquid crystal panel in which RGB are combined.

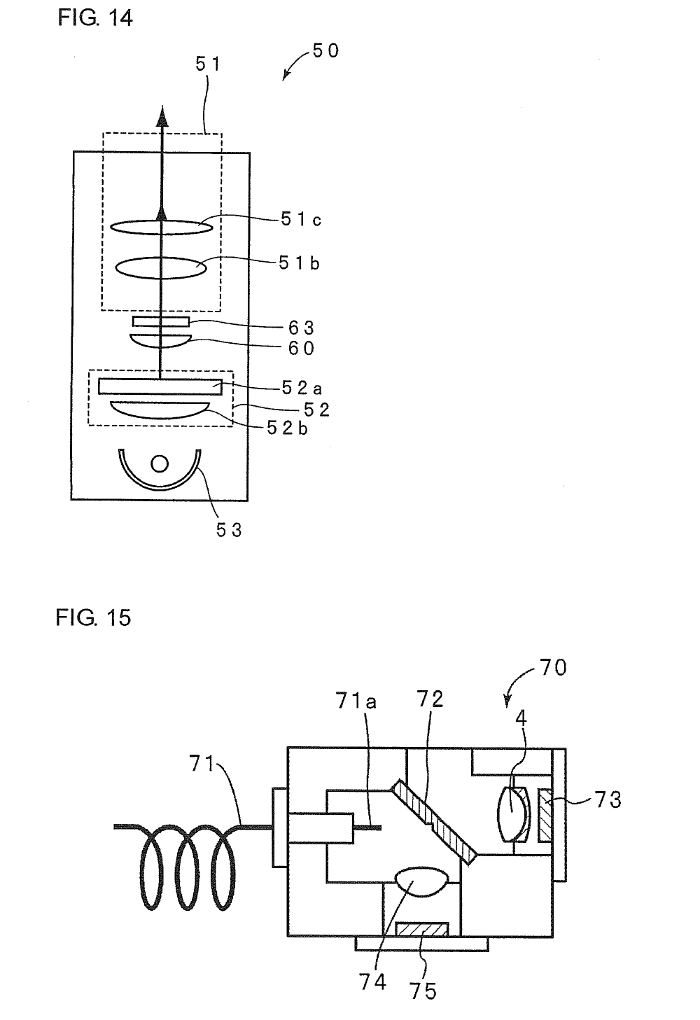

In a liquid crystal projector shown in FIG. 14, white LED is used as the light source 53 for further miniaturization. As shown in FIG. 14, the light radiated from the light source 53 passes through an illuminating optical system 52 and further passes through a lens 60 and a liquid crystal panel 63 and further passes through a projection optical system 51 and is radiated outside.

As shown in FIG. 14, components from the light source 53 to the projection optical system 51 can be arranged on a straight line. In such a case, use of a lens of Examples according to the invention for the lenses 51a, 51b, and 51c of the projection optical system 51 makes the focal length short and therefore, the entire length of the liquid crystal projector can be shortened.

### APPLICATION EXAMPLE 5

FIG. 15 is a schematic cross-sectional view showing an optical transmitter and receiver module using a composite type aspherical lens 4, which is an optical component of the invention.

In an optical transmitter and receiver module 70, one end 71a of an optical fiber 71 is inserted and a light emitting device 73 is provided on a position facing to the other end 71a of the optical fiber 71. The composite type aspherical lens 4 of the invention is provided in front of the light emitting device 73 and a wavelength selection filter 72 tilted at 45° is installed between the composite type aspherical lens 4 and the end 71a of the optical fiber 71. A light receiving device 75 is provided under the wavelength selection filter 72 while a lens 74 is set between them.

The light radiated from the light emitting device 73 passes through the composite type aspherical lens 4 and passes through the wavelength selection filter 72 and enters in the optical fiber 71 from the end 71a and is transmitted.

Further, the light transmitted from the optical fiber 71 passes through the end part 71a, is reflected by the wavelength selection filter 72, passes through the lens 74, and is received by the light receiving device 75.

In the optical transmitter and receiver module, since the composite type aspherical lens 4 of the invention is used, the focal distance can be shortened and the module can be miniaturized.

1. An optical polymer material containing: a fluorene compound having four (meth)acryloyl groups; and a (meth)acrylate having an aryl group.

2. The optical polymer material according to claim 1, wherein an organometallic polymer is contained as said (meth)acrylate having an aryl group, said organometallic polymer having a (meth)acryloyl group, an -M-O-M- bond (M is a metal atom), and an aryl group.

3. The optical polymer material according to claim 1, wherein a (meth)acrylate having a phenylphenol group is contained as said (meth)acrylate having an aryl group contains.

4. The optical polymer material according to claim 1 further containing a monofunctional (meth)acrylate and/or a polyfunctional (meth)acrylate.

5. The optical polymer material according to claim 1, wherein the content of said fluorene compound is 40 to 70% by weight and the content of said (meth)acrylate having an aryl group is 10 to 60% by weight.

6. The optical polymer material according to claim 2, wherein the content of said organometallic polymer is 10 to 30% by weight.

7. The optical polymer material according to claim 4, wherein the content of said monofunctional (meth)acrylate is 25% by weight or less, and the content of said polyfunctional (meth)acrylate is 15% by weight or less.

8. An optical component comprising a light transmitting region formed by curing the optical polymer material according to claim 1.

9. The optical component according to claim 8, wherein the optical component is a composite optical device comprising said light transmitting region formed on a translucent member.

10. The optical component according to claim 9, wherein said translucent member includes a plastic, and a coating layer of a metal oxide is provided on said light transmitting region.

11. An optical apparatus comprising the optical component according to claim 1.

12. The optical polymer material according to claim 2, wherein a (meth)acrylate having a phenylphenol group is contained as said (meth)acrylate having an aryl group contains.

13. The optical polymer material according to claim 2 further containing a monofunctional (meth)acrylate and/or a polyfunctional (meth)acrylate.

14. The optical polymer material according to claim 2, wherein the content of said fluorene compound is 40 to 70% by weight and the content of said (meth)acrylate having an aryl group is 10 to 60% by weight.

15. The optical polymer material according to claim 3 further containing a monofunctional (meth)acrylate and/or a polyfunctional (meth)acrylate.

16. The optical polymer material according to claim 3, wherein the content of said fluorene compound is 40 to 70% by weight and the content of said (meth)acrylate having an aryl group is 10 to 60% by weight.

17. The optical polymer material according to claim 4, wherein the content of said fluorene compound is 40 to 70% by weight and the content of said (meth)acrylate having an aryl group is 10 to 60% by weight.
